(19) United States
(12) Patent Application Publication
(10) Pub. No.: US 2025/0310654 A1
(43) Pub. Date: Oct. 2, 2025

(54) IMAGING DEVICE, IMAGING METHOD, AND PROGRAM

(71) Applicant: Sony Group Corporation, Tokyo (JP)

(72) Inventors: Hiroki Ohtsuki, Tokyo (JP); Yohei Myoga, Tokyo (JP)

(21) Appl. No.: 18/857,327

(22) PCT Filed: May 8, 2023
(86) PCT No.: PCT/JP2023/017330

§ 371 Date: Jun. 23, 2025

(30) Foreign Application Priority Data
May 26, 2022 (JP) 2022-085823

(51) Int. Cl. H04N 25/13

(52) U.S. Cl. CPC H04N 25/134

(57) ABSTRACT

The present technology relates to an imaging device, an imaging method, and a program capable of improving image quality.

An imaging device includes a pixel array unit in which pixels that generate charges according to an amount of light received and output signals according to the charges are arrayed in a matrix in a row direction and a column direction; a reading unit that divides the pixel array unit into a plurality of blocks and reads a signal from the pixel at a same position in the block from each of the plurality of blocks; and a rearrangement unit that performs rearrangement such that an array of the signals read by the reading unit is equivalent to an array of the pixels in the pixel array unit. The present technology can be applied to, for example, an imaging device.

### TECHNICAL FIELD

The present technology relates to an imaging device, an imaging method, and a program, and for example, relates to an imaging device, an imaging method, and a program that enable application of existing processing even in a case where a reading method from a pixel is changed.

### BACKGROUND ART

A general imaging element includes a Bayer array color filter. In the Bayer array, green (G) is arranged in a checkered pattern, and red (R) and blue (B) are arranged in line order. Patent Document 1 has proposed a technology that enables an existing processing unit for Bayer array to be used for signal processing of an imaging element using a color filter array including white.

### CITATION LIST

### Patent Document

Patent Document 1: Japanese Patent Application Laid-Open No. 2014-161022

### SUMMARY OF THE INVENTION

### Problems to be Solved by the Invention

A method called raster scanning is used as a method of reading a pixel signal from an imaging element in a Bayer array. A processing unit that processes a pixel signal read by raster scanning is generally used.

On the other hand, when reading is performed by raster scan, a time difference occurs between a line to be read first and a write to be read last, and distortion may occur in an image.

Even in a case where a reading method for preventing distortion from occurring in an image is applied, it is desired to be able to apply existing processing.

The present technology has been made in view of such a situation, and is intended to improve image quality.

### Solutions to Problems

An imaging device according to an aspect of the present technology is an imaging device including a pixel array unit in which pixels that generate charges according to an amount of light received and output signals according to the charges are arrayed in a matrix in a row direction and a column direction; a reading unit that divides the pixel array unit into a plurality of blocks and reads a signal from the pixel at a same position in the block from each of the plurality of blocks; and a rearrangement unit that performs rearrangement such that an array of the signals read by the reading unit is equivalent to an array of the pixels in the pixel array unit.

An imaging method according to another aspect of the present technology is an imaging method including, by an imaging device including a pixel array unit in which pixels that generate charges according to an amount of light received and output signals according to the charges are arrayed in a matrix in a row direction and a column direction, dividing the pixel array unit into a plurality of blocks and reading the signal from the pixel at a same position in the block from each of the plurality of blocks; and performing rearrangement such that an array of the read signals is equivalent to an array of the pixels in the pixel array unit.

A program according to still another aspect of the present technology is a program causing a computer that controls an imaging device including a pixel array unit in which pixels that generate charges according to an amount of light received and output signals according to the charges are arrayed in a matrix in a row direction and a column direction, to execute processing including steps of dividing the pixel array unit into a plurality of blocks and reading the signal from the pixel at a same position in the block from each of the plurality of blocks; and performing rearrangement such that an array of the read signals is equivalent to an array of the pixels in the pixel array unit.

In the imaging device, the imaging method, and the program according to the aspects of the present technology, a pixel array unit in which pixels that generate charges according to an amount of light received and output signals according to the charges are arrayed in a matrix in a row direction and a column direction is provided, the pixel array unit is divided into a plurality of blocks and a signal is read from the pixel at the same position in the block from each of the plurality of blocks, and rearrangement is performed such that an array of the read signals is equivalent to an array of the pixels in the pixel array unit.

Note that the imaging device may be an independent device or an internal block constituting one device.

Note that a program can be provided by being transmitted via a transmission medium or being recorded on a recording medium.

### BRIEF DESCRIPTION OF DRAWINGS

FIG. 1 is a diagram illustrating a configuration of an embodiment of an imaging device to which the present technology is applied.

FIG. 2 is a diagram illustrating a configuration example of a pre-stage processing unit.

FIG. 3 is a diagram for describing a pixel array in a pixel array unit.

FIG. 4 is a diagram for describing a reading order.

FIG. 5 is a diagram for describing a reading order.

FIG. 6 is a diagram illustrating an arrangement example of pixel signals stored in a storage unit 102.

FIG. 7 is a diagram for describing processing of a horizontal rearrangement unit.

FIG. 8 is a diagram for describing processing of a vertical rearrangement unit.

FIG. 9 is a diagram for describing vertical rearrangement.

FIG. 10 is a diagram for describing compression processing.

FIG. 11 is a diagram for describing processing of an interpolation unit.

FIG. 12 is a diagram illustrating a configuration example of a PC.

### MODE FOR CARRYING OUT THE INVENTION

Hereinafter, a mode for carrying out the present technology (hereinafter, referred to as an embodiment) will be described.

### Configuration Example of Imaging Device

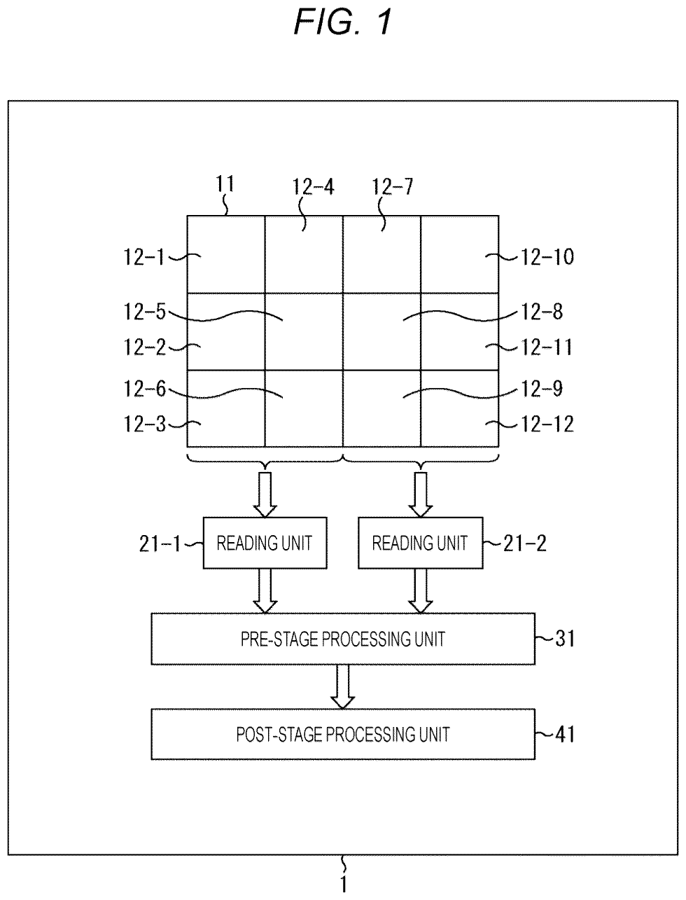

FIG. 1 is a diagram illustrating a configuration example of an embodiment of an imaging device to which the present technology is applied. An imaging device 1 includes a pixel array unit 11, a reading unit 21-1, a reading unit 21-2, a pre-stage processing unit 31, and a post-stage processing unit 41.

The pixel array unit 11 has a configuration in which pixels that generate charges according to the amount of received light and output signals according to the charges are arrayed in a matrix in a row direction and a column direction. That is, the pixel array unit 11 has a plurality of pixels that photoelectrically converts the incident light and outputs signals according to charges obtained as a result of the photoelectric conversion. Here, the row direction refers to an array direction of the pixels in a horizontal direction, and the column direction refers to an array direction of the pixels in a vertical direction. Note that, the row direction is a transverse direction in the drawing, and the column direction is a longitudinal direction in the drawing.

The pixel array unit 11 is divided into 12 blocks 12-1 to 12-12. In the following description, in a case where it is not necessary to individually distinguish the blocks 12-1 to 12-12, the blocks will be simply described as blocks 12. Other parts will be described in a similar manner.

In the example illustrated in FIG. 1, a case where the pixel array unit 11 is divided into 12 blocks 12 will be described as an example, but the number of divisions may be 12 or less or 12 or more. Other numerical values are also numerical values for description, and are not descriptions indicating limitations.

In one block 12, m×n pixels are arranged. The imaging device 1 includes a reading unit 21-1 that reads signals from the blocks 12-1 to 12-6 arranged on the left side of the pixel array unit 11 in the drawing, and a reading unit 21-2 that reads signals from the blocks 12-7 to 12-12 arranged on the right side of the pixel array unit 11 in the drawing.

Each of the reading unit 21-1 and the reading unit 21-2 supplies the read signals to the pre-stage processing unit 31. Although the details will be described later, for example, in a case where the reading unit 21-1 reads a signal from a pixel arranged at a position of coordinates A (ma, na) within the block 12-1, the reading unit 21-2 reads a signal from a pixel arranged at a position of the coordinates A (ma, na) arranged at the position A within the block 12-7.

The coordinates A are coordinates representing the position of the coordinates in each block 12, and are, for example, coordinates in which the coordinates of the lower left pixel is set as (0, 0) for each block 12.

The blocks 12-1 to 12-6 to be read by the reading unit 21-1 are set as a block group A. The blocks 12-7 to 12-12 to be read by the reading unit 21-2 are set as a block group B. The pixels to be read at the same timing by the respective reading units 21 are in the blocks 12 arranged at the same position in the block group A and the block group B.

For example, in a case where the reading unit 21-1 reads a signal from a pixel in the block 12-1 positioned at the upper left in the block group A, the reading unit 21-2 reads a signal from a pixel in the block 12-7 positioned at the upper left in the block group B. In a case where the reading unit 21-1 reads a signal from a pixel arranged at the position of the coordinates A (ma, na) in the block 12-1, the reading unit 21-2 reads a signal from a pixel arranged at the position of the coordinates A (ma, na) in the block 12-7.

As described above, the reading unit 21-1 and the reading unit 21-2 are configured to read signals from pixels arranged at the same position in the blocks that are at the same position in the block groups at substantially the same timing. The reading unit 21-1 and the reading unit 21-2 read signals from predetermined pixels at substantially the same timing, and supply the signals to the pre-stage processing unit 31, but a slight deviation may occur in the reading. As will be described later, the pre-stage processing unit 31 has a configuration to execute processing of absorbing the deviation at the time of reading the pixel signal.

In a case where attention is paid to the reading unit 21-1, the reading unit 21-1 performs reading from the pixel arranged at the coordinates A (ma, mb) in the block 12-1, and then performs reading from the pixel arranged at the coordinates A (ma, mb) in the block 12-2 (or the block 12-4) adjacent to the block 12-1.

As described above, the reading unit 21 sequentially reads the pixel signals from the pixels arranged at the same coordinates in the blocks 12.

The pre-stage processing unit 31 converts the arrangement of the pixel signals read from the pixel array unit 11 to be equivalent to the arrangement in a case where the pixel signals are read by raster scanning of so-called Bayer array, and supplies the pixel signals to the post-stage processing unit 41.

The post-stage processing unit 41 is a processing unit that processes the signals read by raster scanning from the pixel array unit of the Bayer array, and can be configured by a large-scale integration (LSI) in the related art.

### Configuration of Pre-Stage Processing Unit

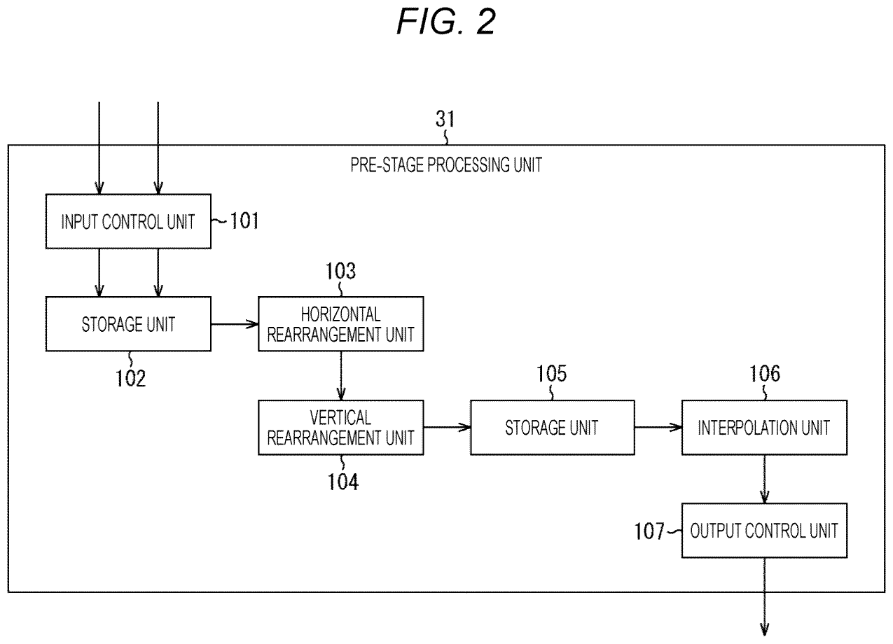

FIG. 2 is a diagram illustrating a configuration example of the pre-stage processing unit 31. The pre-stage processing unit 31 includes an input control unit 101, a storage unit 102, a horizontal rearrangement unit 103, a vertical rearrangement unit 104, a storage unit 105, an interpolation unit 106, and an output control unit 107.

The input control unit 101 has a configuration including a physical layer (PHY) and a link layer (LINK), and supplies the pixel signals supplied from each of the reading unit 21-1 and the reading unit 21-2 to the storage unit 102 to store. The storage unit 102 includes, for example, a buffer, and sequentially stores the pixel signals input under the control of the input control unit 101.

Since the pixel signals from the pixel array unit 11 are read by the reading unit 21-1 and the reading unit 21-2, data strings (pixel signals) of two left and right systems are input to the storage unit 102. It is preferable that the deviation does not occur in the data strings of the two systems, but for example, there is a possibility that a deviation of up to one line occurs. Processing for absorbing this deviation is performed by performing synchronization processing with the buffering in the storage unit 102 (buffer).

When reading the pixel signals from the storage unit 102, the horizontal rearrangement unit 103 rearranges the arrangement of the pixels in the horizontal direction (row direction), and supplies the rearranged pixels to the vertical rearrangement unit 104.

The pixel signals are read in an order different from the arrangement of the pixels in the pixel array unit 11, and are sequentially stored in the storage unit 102. The arrangement of pixels stored in the storage unit 102 is different in each of the horizontal direction and the vertical direction (the row direction and the column direction) as compared with the arrangement of the pixels in the pixel array unit 11. The horizontal rearrangement unit 103 reads the pixel signals from the storage unit 102 while changing the arrangement of the pixels in the horizontal direction so that the pixels are arranged in the horizontal direction of the pixel array unit 11, and supplies the pixel signals to the vertical rearrangement unit 104.

When causing the storage unit 105 in the subsequent stage to store the pixel signals, the vertical rearrangement unit 104 supplies the pixel signals to the storage unit and causes the storage unit 105 to store the pixel signals while changing the arrangement of the pixels in the vertical direction so that the pixels are arranged in the vertical direction of the pixel array unit 11.

The storage unit 105 is a frame memory, and includes, for example, a static random access memory (SRAM), or a dynamic random access memory (DRAM). The pixel signals stored in the storage unit 105 are output to the interpolation unit 106. As will be described later, in a case where the pixel for phase difference detection is arranged in the pixel array unit 11, the pixel signal is supplied to the interpolation unit 106 in a state where there is no pixel signal of the normal pixel corresponding to the position where the pixel for phase difference detection is arranged. Therefore, processing of interpolating the pixel signal of the normal pixel is performed by the interpolation unit 106.

By interpolating pixels as necessary, the pixel signals stored in the storage unit 105 are supplied to the output control unit 107. The pixel signals output from the output control unit 107 are supplied to the post-stage processing unit 41 (FIG. 1) in the order of output in a case where the pixels of the pixel array unit 11 are in the Bayer array and are read by raster scanning. As the post-stage processing unit 41, a processing unit in the related art, which processes signals from the pixel array unit 11, can be applied.

### Regarding Reading Order from Pixel Array Unit

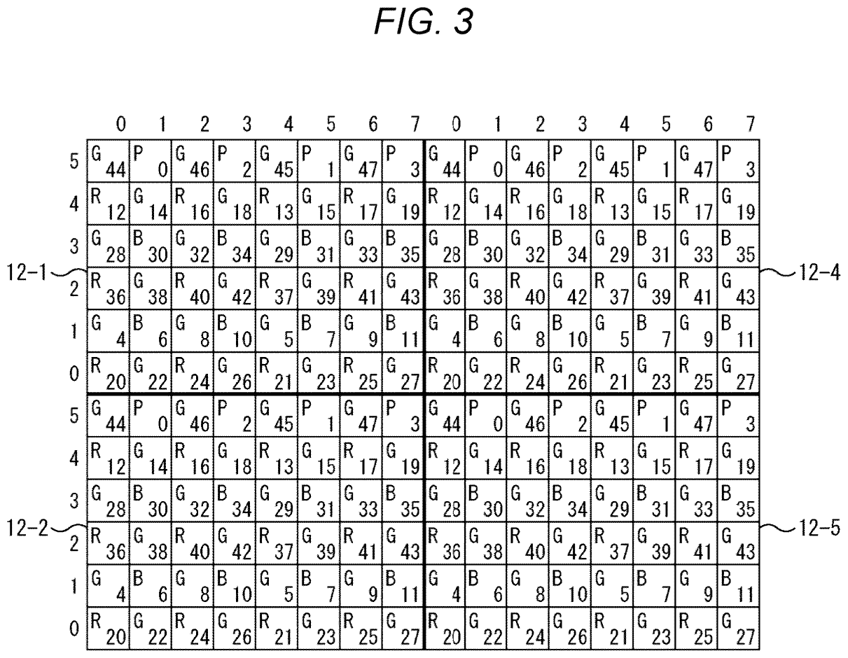

FIG. 3 is a diagram illustrating blocks 12-1, 12-2, 12-4, and 12-5 arranged in the pixel array unit 11 and illustrating colors of pixels arranged in each block 12 and the reading order.

The block 12 includes a total of 48 pixels including 8 pixels in the horizontal direction and 6 pixels in the vertical direction. Note that, here, a case where 48 pixels are included in one block 12 will be described as an example, but the number of pixels included in one block 12 is not limited in applying the present technology.

In FIG. 3, numerical values 0 to 7 illustrated on the upper side of the block 12-1 in the drawing represent the coordinates of the pixels in the block 12-1 in the horizontal direction (x axis), and numerical values 0 to 5 illustrated on the left side of the block 12-1 in the drawing represent the coordinates of the pixels in the block 12-1 in the vertical direction (y axis). The lower left coordinates of the block 12-1 are (0, 0).

In FIG. 3, one rectangle represents one pixel. An alphabet R in one pixel represents a pixel (hereinafter, described as a pixel G) in which a red color filter is arranged.

Similarly, G indicates a pixel (hereinafter, described as a pixel G) in which a green color filter is arranged, and B indicates a pixel (hereinafter, described as a pixel B) in which a blue color filter is arranged. P represents a pixel for phase difference detection (hereinafter, described as a pixel P).

The pixels arranged in the pixel array unit 11 are arranged in the Bayer array except for a portion where the pixels P are arranged. The pixel P is arranged at a position corresponding to the pixel B in the Bayer array.

In FIG. 3, the numerical value described in one pixel (in one rectangle) represent the reading order by the reading unit 21. In the example illustrated in FIG. 3, since 48 pixels are included in one block 12, numbers 0 to 47 are allocated to respective pixels. Note that, since numbers are assigned from 0, the 0th reading means first reading from the block 12, and the reading operation means reading in the first reading operation. In the following description, n-th reading means reading by the (n+1) th reading operation of the operation of reading the signal of the pixel in the block 12 by the reading unit 21.

In the example illustrated in FIG. 3, for example, a pixel in coordinates (0, 0) is a red pixel R, and indicates a pixel of which a pixel signal is read 20th. The pixel in coordinates (1, 0) is a green pixel G, and is a pixel of which a pixel signal is read 22nd. In the following description, in a case where it is desired to include the reading order, for example, the pixel R in coordinates (0, 0) is described as a pixel R20. In such a case, the numerical value added after the pixel is a numerical value representing the reading order.

In the 0th row (coordinates (0, 0) to (7, 0)) of the block 12-1 illustrated in FIG. 3, a pixel R20, a pixel G22, a pixel R24, a pixel G26, a pixel R21, a pixel G23, a pixel R25, and a pixel G27 are arranged. In the first row (coordinates (0, 1) to (7, 1)) of the block 12-1, a pixel G4, a pixel B6, a pixel G8, a pixel B10, a pixel G5, a pixel B7, a pixel G9, and a pixel B11 are arranged.

In the second row (coordinates (0, 2) to (7, 2)) of the block 12-1, a pixel R36, a pixel G38, a pixel R40, a pixel G42, a pixel R37, a pixel G39, a pixel R41, and a pixel G43 are arranged. In the third row (coordinates (0, 3) to (7, 3)) of the block 12-1, a pixel G28, a pixel B30, a pixel G32, a pixel B34, a pixel G29, a pixel B31, a pixel G33, and a pixel B35 are arranged.

In the 0th row (coordinates (0, 4) to (7, 4)) of the block 12-4, a pixel R12, a pixel G14, a pixel R16, a pixel G18, a pixel R13, a pixel G15, a pixel R17, and a pixel G19 are arranged. In the fifth row (coordinates (0, 5) to (7, 5)) of the block 12-1, a pixel G44, a pixel P0, a pixel G46, a pixel P2, a pixel G45, a pixel P1, a pixel G47, and a pixel P3 are arranged.

Here, the arrangement of the pixels in the block 12-1 has been described as an example, but the arrangement of the pixels in the block 12 other than the block 12-1 is also similar to the arrangement of the pixels in the block 12-1 described here. That is, this means that the arrangement of the pixels in the block 12 is the same in all the blocks 12, and the reading order is the same for each block 12.

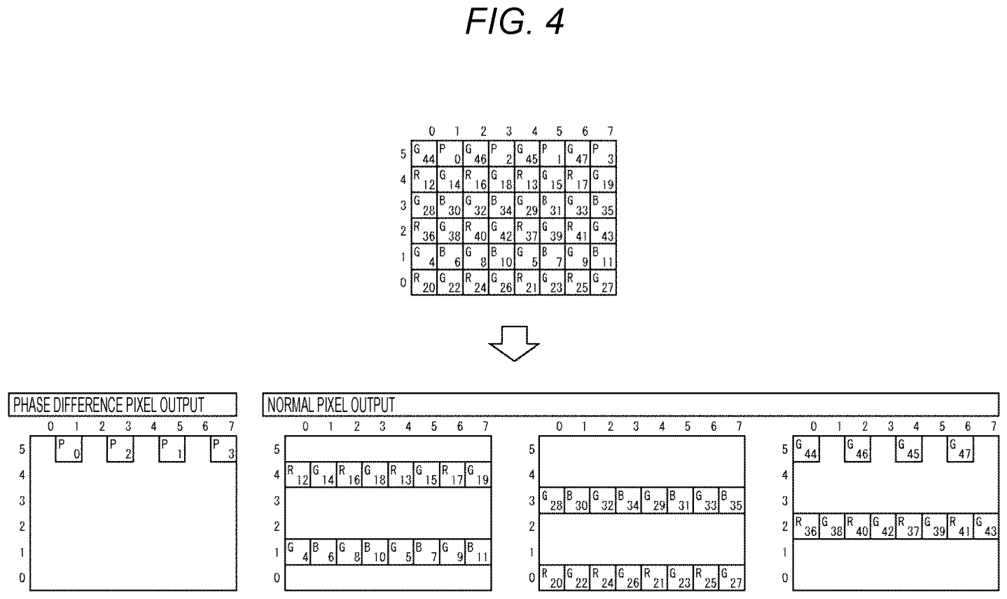

As described above, the order of the pixels of which the pixel signals are read from the block 12 is different from the order in the case of the reading by normal raster scanning. The reading unit 21 reads the pixel signals from the block 12 in such a reading order, and moreover, as illustrated in FIG. 4, the reading unit 21 performs reading for the phase difference pixels and the normal pixels separately. The phase difference pixel is a pixel P, and the normal pixel is a pixel R, a pixel G, and a pixel B.

The reading of the normal pixels is performed in three parts. As illustrated in FIG. 4, when the reading unit 21 reads the pixel signals from the predetermined block 12 of the pixel array unit 11, the reading unit 21 first reads the pixel signal from the phase difference pixel, and thereafter, reads the pixel signal from the normal pixel in three parts. Since the normal pixel is a pixel used to generate an image, in this case, one frame is read in three parts.

The reading unit 21 reads the pixel signals from the phase difference pixels P arranged in the fifth row in the block 12. Next, the reading unit 21 reads pixel signals from the normal pixels arranged in the first row and the fourth row in the block 12. Next, the reading unit 21 reads pixel signals from the normal pixels arranged in the 0th row and the third row in the block 12. Next, the reading unit 21 reads pixel signals from the normal pixels arranged in the second row and the fifth row in the block 12.

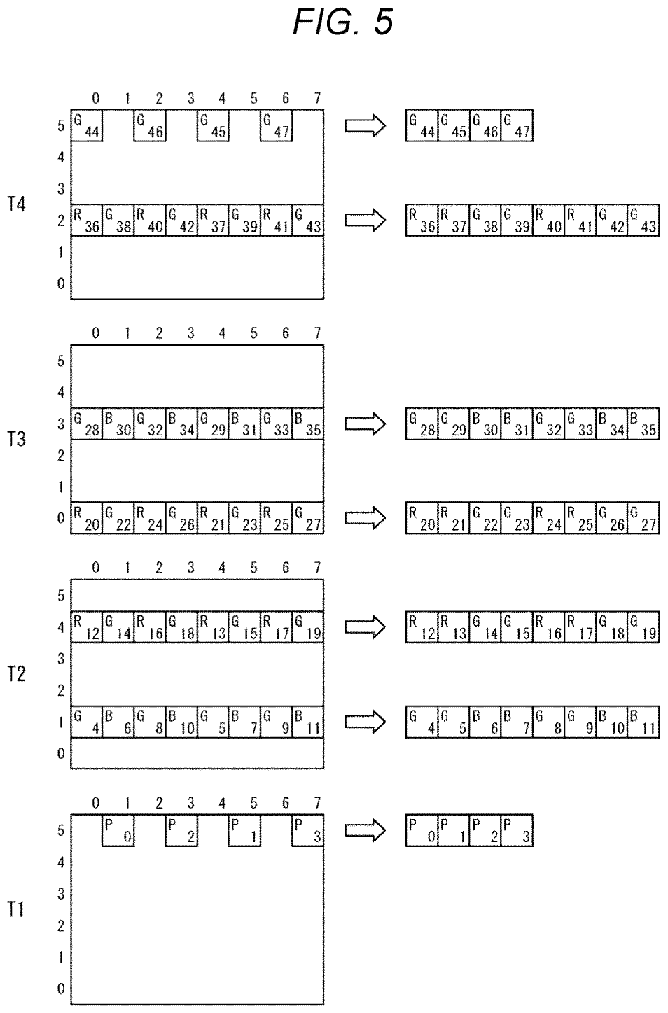

When the reading unit 21 reads the pixel signals from the block 12, the reading unit 21 performs the reading on the basis of the reading order set in the block 12. Reading in the reading order will be described with reference to FIG. 5.

In a reading period T1, the pixel signals are read from the phase difference pixels P. The pixels P are arranged in the block 12 in the order of the pixel P0, the pixel P2, the pixel P1, and the pixel P3 from the left side. At the time of reading, since reading is performed in an ascending order of the reading numbers, in this case, reading is performed in the order of the pixel P0, the pixel P1, the pixel P2, and the pixel P3.

In a reading period T2, the pixel signals are read from the normal pixels. In the reading period T2, signals from the pixels arranged in the first row and the fourth row in the block 12 are to be read. Among the pixels arranged in the first row and the fourth row in the block 12, the pixel having the smallest reading number is the pixel G4 arranged in coordinates (0, 1). Therefore, in the reading period T2, the reading is started from the pixel G4.

In the example illustrated in FIG. 5, the reading is performed in the order of the pixel G4, the pixel G5, the pixel B6, the pixel B7, the pixel G8, the pixel G9, the pixel B10, and the pixel B11 in the first row. Subsequently, the reading is performed in the order of the pixel R12, the pixel R13, the pixel G14, the pixel G15, the pixel R16, the pixel R17, the pixel G18, and the pixel G19.

In a reading period T3, the pixel signals are read from the normal pixels. In the reading period T3, signals from the pixels arranged in the 0th row and the third row in the block 12 are to be read. Among the pixels arranged in the 0th row and the third row in the block 12, the pixel having the smallest reading number is the pixel R20 arranged in coordinates (0, 0). Therefore, in the reading period T3, the reading is started from the pixel R20.

In the example illustrated in FIG. 5, the reading is performed in the order of the pixel R20, the pixel R21, the pixel G22, the pixel G23, the pixel R24, the pixel R25, the pixel G26, and the pixel G27 in the 0th row. Subsequently, the reading is performed in the order of the pixel G28, the pixel G29, the pixel B30, the pixel B31, the pixel G32, the pixel G33, the pixel B34, and the pixel B35 in the third row.

In a reading period T4, the pixel signals are read from the normal pixels. In the reading period T4, signals from the pixels arranged in the second row and the fifth row in the block 12 are to be read. Among the pixels arranged in the second row and the fifth row in the block 12, the pixel having the smallest reading number is the pixel R36 arranged in coordinates (0, 2). Therefore, in the reading period T4, the reading is started from the pixel R36.

In the example illustrated in FIG. 5, the reading is performed in the order of the pixel R36, the pixel R37, the pixel G38, the pixel G39, the pixel R40, the pixel R41, the pixel G42, and the pixel G43 in the second row. Subsequently, the reading is performed in the order of the pixel G44, the pixel G45, the pixel G46, and the pixel G47 in the fifth row. In the fifth row, since the phase difference pixels P are arranged and have already been read at the time of the reading period T4, only the pixel signals of the four pixels G44 to G47 are read from the fifth row.

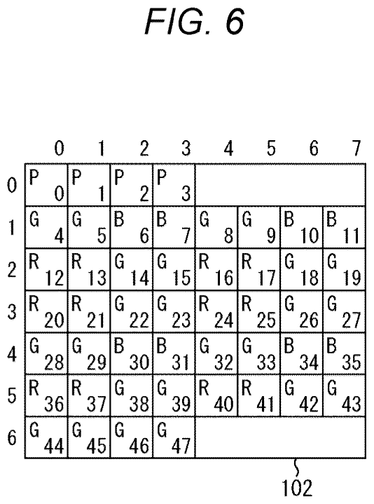

In a case where the reading is performed in such an order and the writing is performed to the storage unit 102 in the reading order, the pixel signals are stored as illustrated in FIG. 6. FIG. 6 is a diagram illustrating an arrangement example of the pixel signals read from the block 12 stored in the storage unit 102. FIG. 6 conceptually illustrates an example in which the pixel signals are stored in the reading order from the reading unit 21, sequentially from the upper left of a storage region of the storage unit 102.

The address in the storage unit 102 is represented by a coordinate system in which the upper left in the drawing is (0, 0), and the description will be continued on the assumption that the pixel signals are sequentially stored from the coordinates (0, 0). The pixel P0, the pixel P1, the pixel P2, and the pixel P3 are stored in order from the left side (upper left in the drawing) of the first row of the storage unit 102. This is the order of the reading in the reading period T1.

In the first row and the second row of the storage unit 102, the pixel signals are written in the order of pixels read from the first row and the fourth row in the block 12 in the reading period T2. In the third row and the fourth row of the storage unit 102, the pixel signals are written in the order of pixels read from the 0th row and the third row in the block 12 in the reading period T3.

In the fifth row and the sixth row of the storage unit 102, the pixel signals are written in the order of pixels read from the second row and the fifth row in the block 12 in the reading period T4.

Here, the reading from one block 12 has been described as an example, but similar reading is performed in all the blocks 12 arranged in the pixel array unit 11. The pixels with the same reading number in each block 12 are read at the same timing. For example, the pixel P0 that is first read in the block 12 is also first read in each block 12 of the blocks 12-1 to 12-12 and read all at once. Thereafter, the pixels P1 to be read second are simultaneously read in each block 12 of the blocks 12-1 to 12-12.

The imaging device 1 illustrated in FIG. 1 includes two systems of reading units 21, and the left half and the right half of the pixel array unit 11 are read by the respective reading units 21. When the pixel P0 is read from the block 12-1, the pixel P0 is also read from the block 12-7. Thereafter, when the pixel P0 is read from the block 12-2, the pixel P0 is also read from the block 12-8. As described above, the left side and the right side of the pixel array unit 11 are configured such that signals from pixels corresponding to the same position are read at substantially the same timing.

The pixels read at the same timing are preferably supplied to and stored in the storage unit 102 at the same timing, but there is a possibility that a deviation occurs in the storage timing. When the reading is performed from the storage unit 102 by the horizontal rearrangement unit 103, it is possible to perform processing in which the deviation is absorbed by adjusting the reading timing and performing reading in which the deviation is absorbed.

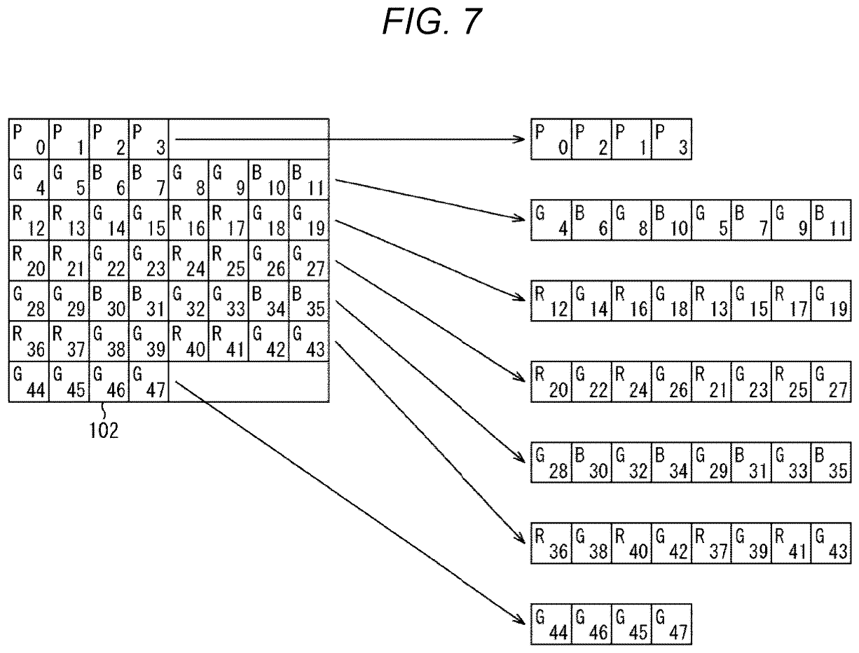

When the pixel signal is buffered in the storage unit 102 as illustrated in FIG. 6, the horizontal rearrangement unit 103 performs the rearrangement of the pixels. The processing of the horizontal rearrangement unit 103 will be described with reference to FIG. 7.

The left diagram of FIG. 7 is a diagram illustrating the arrangement of pixel signals stored in the storage unit 102, and is the same as the diagram illustrated in FIG. 6. In a case where the pixels P0 to P3 arranged in the 0th row are read, the horizontal rearrangement unit 103 reads the pixel P0, the pixel P2, the pixel P1, and the pixel P3 in this order, and outputs the pixel P0, the pixel P2, the pixel P1, and the pixel P3 to the vertical rearrangement unit 104 in the subsequent stage. This reading order is the order in which the phase difference pixels P are arranged in the fifth row in the block 12 illustrated in FIG. 3.

As described above, when the pixels are read from the storage unit 102, the horizontal rearrangement unit 103 reads the pixels from the storage unit 102 such that the pixels are arranged in the pixel array order arranged in the pixel array unit 11 in the horizontal direction (x-axis direction).

Reading is similarly performed on the rows other than the 0th row stored in the storage unit 102. That is, when reading the pixels arranged in the order of the pixel G4, the pixel G5, the pixel B6, the pixel B7, the pixel G8, the pixel G9, the pixel B10, and the pixel B11 arranged in the first row, the horizontal rearrangement. unit 103 reads the pixel G4, the pixel B6, the pixel G8, the pixel B10, the pixel G5, the pixel B7, the pixel G9, and the pixel B11 in this order. This reading order is the order in which the pixels G and the pixels B are alternately arranged in the first row in the block 12 illustrated in FIG. 3.

When reading the pixels arranged in the order of the pixel R12, the pixel R13, the pixel G14, the pixel G15, the pixel R16, the pixel R17, the pixel G18, and the pixel G19 arranged in the second row, the horizontal rearrangement unit 103 reads the pixel R12, the pixel G14, the pixel R16, the pixel G18, the pixel R13, the pixel G15, the pixel R17, and the pixel G19 in this order. This reading order is the order in which the pixels R and the pixels G are alternately arranged in the fourth row in the block 12 illustrated in FIG. 3.

When reading the pixels arranged in the order of the pixel R20, the pixel R21, the pixel G22, the pixel G23, the pixel R24, the pixel R25, the pixel G26, and the pixel G27 arranged in the third row, the horizontal rearrangement unit 103 reads the pixel R20, the pixel G22, the pixel R24, the pixel G26, the pixel R21, the pixel G23, the pixel R25, and the pixel G27 in this order. This reading order is the order in which the pixels R and the pixels G are alternately arranged in the 0th row in the block 12 illustrated in FIG. 3.

When reading the pixels arranged in the order of the pixel G28, the pixel G29, the pixel B30, the pixel B31, the pixel G32, the pixel G33, the pixel B34, and the pixel B35 arranged in the fourth row, the horizontal rearrangement unit 103 reads the pixel G28, the pixel B30, the pixel G32, the pixel B34, the pixel G29, the pixel B31, the pixel G33, and the pixel B35 in this order. This reading order is the order in which the pixels G and the pixels B are alternately arranged in the third row in the block 12 illustrated in FIG. 3.

When reading the pixels arranged in the order of the pixel R36, the pixel R37, the pixel G38, the pixel G39, the pixel R40, the pixel R41, the pixel G42, and the pixel G43 arranged in the fifth row, the horizontal rearrangement unit 103 reads the pixel R36, the pixel G38, the pixel R40, the pixel G42, the pixel R37, the pixel G39, the pixel R41, and the pixel G43 in this order. This reading order is the order in which the pixels R and the pixels G are alternately arranged in the second row in the block 12 illustrated in FIG. 3.

When reading the pixels arranged in the order of the pixel G44, the pixel G45, the pixel G46, and the pixel G47 arranged in the sixth row, the horizontal rearrangement unit 103 reads the pixel G44, the pixel G46, the pixel G45, and the pixel G47 in this order. This reading order is the order in which the pixels G in the fifth row in the block 12 illustrated in FIG. 3 are arranged. Since the phase difference pixel P is read at a different timing, only the pixels G are read here.

As described above, the horizontal rearrangement unit 103 performs rearrangement in the horizontal direction, so that the array of the pixels, which are output from the horizontal rearrangement unit 103, in the horizontal direction is the same as the array in the horizontal direction of the pixel array unit 11. The output from the horizontal rearrangement unit 103 is supplied to the vertical rearrangement unit 104.

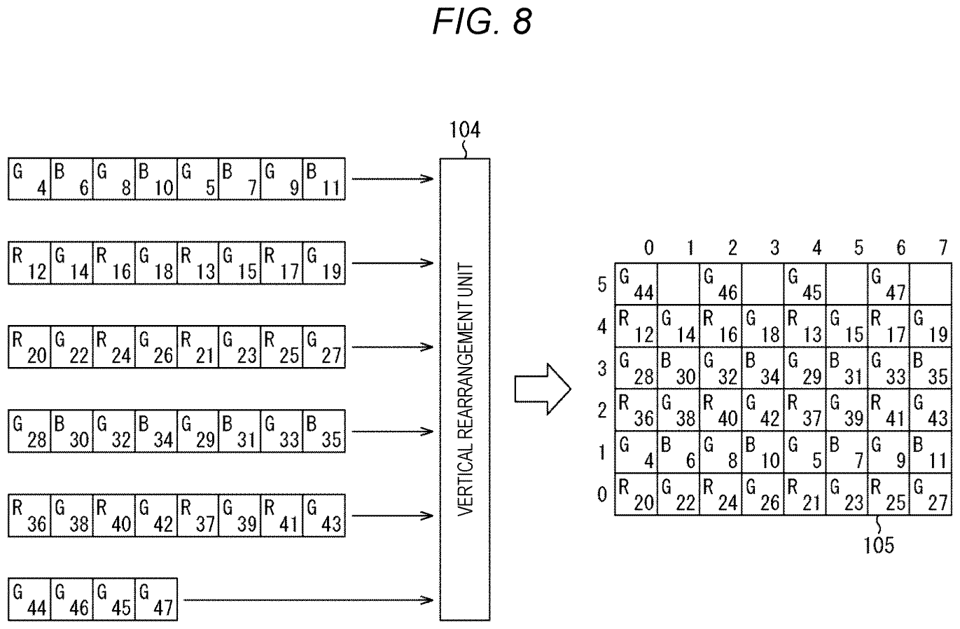

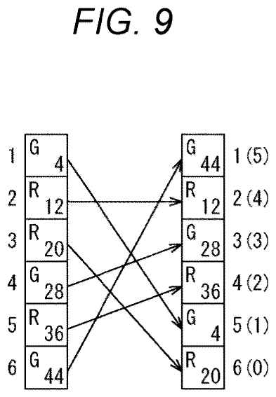

The processing of the vertical rearrangement unit 104 will be described with reference to FIGS. 8 and 9. In a case where the pixel G4 is input to the vertical rearrangement unit 104, the vertical rearrangement unit 104 writes the pixel signal of the pixel G4 to the address of the storage unit 105 corresponding to the coordinates (0, 1) in the block 12 of the pixel array unit 11. Next, when the pixel B6 is input to the vertical rearrangement unit 104, the pixel signal of the pixel B6 is written to the address of the storage unit 105 corresponding to the coordinates (1, 1) in the block 12 of the pixel array unit 11.

Since the pixel column for which the rearrangement has been completed in the horizontal direction by the horizontal rearrangement unit 103 is input to the vertical rearrangement unit 104, the pixel signals from the pixel G4 to the pixel B11 are converted into the row of the storage unit 105 corresponding to the row arranged in the block 12 of the pixel array unit 11, and are sequentially written. The conversion of the row to be written will be described with reference to FIG. 9.

In FIG. 9, the arrangement of the normal pixels in the first column stored in the storage unit 102 is illustrated on the left side, and the arrangement of the normal pixels stored in the first column of the storage unit 105 is illustrated on the right side. A numerical value illustrated on the left side of the rectangle representing the pixel illustrated on the left side of FIG. 9 represents a row number of the storage unit 102. A numerical value illustrated on the right side of the rectangle representing the pixel illustrated on the right side of FIG. 9 represents a row number of the storage unit 105, and a numerical value illustrated in parentheses on the right side thereof represents a row number corresponding to the row number in the block 12 of the pixel array unit 11.

The pixel R4 stored in the first row of the storage unit 102 is written in the fifth row of the storage unit 105, which is the row corresponding to the first row in the block 12. The pixel B6, the pixel G8, the pixel B10, the pixel G5, the pixel B7, the pixel G9, and the pixel B11 (FIG. 8) arranged in the row starting from the pixel R4 are sequentially written in the fifth row of the storage unit 105, which is the row corresponding to the first row in the block 12.

The pixel R12 stored in the second row of the storage unit 102 is written in the second row of the storage unit 105, which is the row corresponding to the fourth row in the block 12. The pixel G14, the pixel R16, the pixel G18, the pixel R13, the pixel G15, the pixel R17, and the pixel G19 (FIG. 8) arranged in the row starting from the pixel R12 are sequentially written in the second row of the storage unit 105, which is the row corresponding to the fourth row in the block 12.

The pixel R20 stored in the third row of the storage unit 102 is written in the sixth row of the storage unit 105, which is the row corresponding to the 0th row in the block 12. The pixel G22, the pixel R24, the pixel G26, the pixel R21, the pixel G23, the pixel R25, and the pixel G27 (FIG. 8) arranged in the row starting from the pixel R20 are sequentially written in the sixth row of the storage unit 105, which is the row corresponding to the 0th row in the block 12.

The pixel G28 stored in the fourth row of the storage unit 102 is written in the third row of the storage unit 105, which is the row corresponding to the third row in the block 12. The pixel B30, the pixel G32, the pixel B34, the pixel G29, the pixel B31, the pixel G33, and the pixel B35 (FIG. 8) arranged in the row starting from the pixel G28 are sequentially written in the third row of the storage unit 105, which is the row corresponding to the third row in the block 12.

The pixel R36 stored in the fifth row of the storage unit 102 is written in the fourth row of the storage unit 105, which is the row corresponding to the second row in the block 12. The pixel G38, the pixel R40, the pixel G42, the pixel R37, the pixel G39, the pixel R41, and the pixel G43 (FIG. 8) arranged in the row starting from the pixel R36 are sequentially written in the fourth row of the storage unit 105, which is the row corresponding to the second row in the block 12.

The pixel G44 stored in the sixth row of the storage unit 102 is written in the first row of the storage unit 105, which is the row corresponding to the fifth row in the block 12. The pixel G46, the pixel G45, and the pixel G47 arranged in the row starting from the pixel G44 are sequentially written in the first row of the storage unit 105, which is the row corresponding to the fifth row in the block 12, by skipping one pixel. Since the phase difference pixels P are arranged in the fifth row of the block 12 of the pixel array unit 11, a portion corresponding to the phase difference pixel P is left blank, and the pixels G44 to G47 are written.

As described above, the vertical rearrangement unit 104 converts the arrangement position of the input pixels (pixel signals) in the vertical direction (y axis) so as to have an arrangement equivalent to the arrangement of the pixels in the block of the pixel array unit 11, and writes the input pixels (pixel signals) in the corresponding region of the storage unit 105.

By the processing so far, the pixels read from the pixel array unit 11 are rearranged in the arrangement in the block 12 of the pixel array unit 11. This arrangement is the same arrangement as when the pixel array unit 11 is raster scanned.

When the vertical rearrangement unit 104 writes the pixel signals to the storage unit 105, the pixel signals may be compressed and then written. When data is written to a memory such as the storage unit 105, the raw data is compressed and then written in order to reduce the bandwidth of the memory capacity. Such a compression technique may be applied to reduce the bandwidth of the storage unit 105.

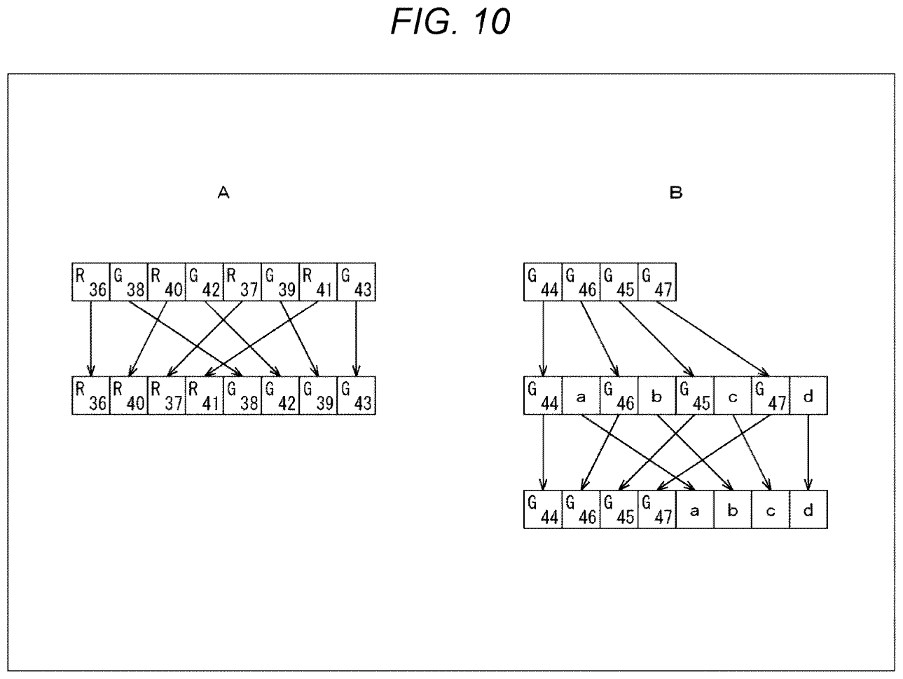

Compression processing performed when the vertical rearrangement unit 104 writes a pixel signal in the storage unit 105 will be described with reference to FIG. 10. A of FIG. 10 is a diagram for describing the compression processing on the pixels read from the row in which the phase difference pixels P are not arranged, and B of FIG. 10 is a diagram for describing the compression processing on the pixels read from the row in which the phase difference pixels P are arranged.

For the compression of RAW data, a compression method using correlation between adjacent pixels can be applied. In a case where the compression method using the correlation between adjacent pixels is applied, in order to increase the compression efficiency, the rearrangement processing in the horizontal direction suitable for the RAW data compression method can be performed together with the rearrangement in the vertical direction.

The compression processing when the pixel R36, the pixel G38, the pixel R40, the pixel G42, the pixel R37, the pixel G39, the pixel R41, and the pixel G43 are written in the storage unit 105 will be described in A of FIG. 10. When the pixels are compressed in the storage unit 105 in this arrangement, the compression efficiency may be reduced because the pixels R and the pixels G are alternately arranged. Therefore, rearrangement in the horizontal direction is performed such that the pixel R and the pixel R are adjacent to each other and the pixel G and the pixel G are adjacent to each other.

In the example illustrated in A of FIG. 10, at the time of the compression processing, the pixel R40 is moved next to the pixel R36, the pixel R37 is moved next to the pixel R40, and the pixel R41 is moved next to the pixel R37. Furthermore, the pixel G38 is moved next to the pixel R41, the pixel G42 is moved next to the pixel G38, the pixel G39 is moved next to the pixel G42, and the pixel G43 is moved next to the pixel G39. In this manner, by collecting the same color pixels, in other words, by collecting the pixels having high correlation, the compression efficiency can be enhanced at the time of the compression processing.

As described with reference to FIG. 8, each compressed pixel signal is written in the region of the storage unit 105 at the corresponding array position so as to have an array equivalent to the pixel array in the block 12 of the pixel array unit 11.

Such compression processing is performed on the pixel columns arranged in rows other than the row in which the pixel R36 is arranged. In the row in which the phase difference pixels P are arranged, the number of pixels in one row is small because the phase difference pixels P are read first. For example, in the example described with reference to FIG. 8, the row (referred to as row B) in which the phase difference pixels P are arranged corresponds to the fifth row of the storage unit 105, but only four pixels G are arranged. Eight pixels are arranged in the other rows (referred to as rows A).

The compression method with reference to A of FIG. 10 includes rearrangement processing in which pixels of the same color are arranged adjacent to each other from a state in which pixels of different colors are alternately arranged as in the row A. The same compression method can be applied to all the rows by making this method applicable to a row in which the pixels of the same color are adjacent and the number of pixels is smaller than that of the row B, such as the row B.

B of FIG. 10 is a diagram for describing the compression processing on the row in which fewer pixels than the number of pixels in the row A are arranged, such as the row B. The pixels in the row to be compressed are four pixels of the pixel G44, the pixel G46, the pixel G45, and the pixel G47. Since there are only four pixels, four pixels are added to make eight pixels. As illustrated in the middle part of B of FIG. 10, a pixel a is inserted between the pixel G44 and the pixel G46, a pixel b is inserted between the pixel G46 and the pixel G45, a pixel c is inserted between the pixel G45 and the pixel G47, and a pixel d is added after the pixel G47.

The pixels a to d are pixels at positions where the phase difference pixels P are arranged, and are pixels located at positions where the pixels B (blue pixels) are arranged in the case of the row where normal pixels are arranged instead of the phase difference pixels P. The pixels a to d may be pixels virtually allocated as corresponding to the pixel B, or may be pixels brought from other rows or from other blocks 12.

The state illustrated in the middle part of B of FIG. 10 is a state in which one row includes eight pixels and the pixels G and the pixels B (the pixels a to d inserted as corresponding to the pixels B) are alternately arranged, similarly to the state of the row A. Therefore, similar to the row A, compression can be performed by applying the compression method described with reference to A of FIG. 10.

That is, as illustrated in the lower part of B of FIG. 10, the pixel G46 is moved next to the pixel G44, the pixel G45 is moved next to the pixel G46, and the pixel G47 is moved next to the pixel G45. Furthermore, the pixel a is moved next to the pixel G47, the pixel b is moved next to the pixel a, the pixel c is moved next to the pixel b, and the pixel d is moved next to the pixel c.

In this manner, by collecting the pixels having high correlation, the compression efficiency can be enhanced at the time of the compression processing.

By writing the pixel signals subjected to such compression processing in the storage unit 105, the capacity of the storage unit 105 can be reduced.

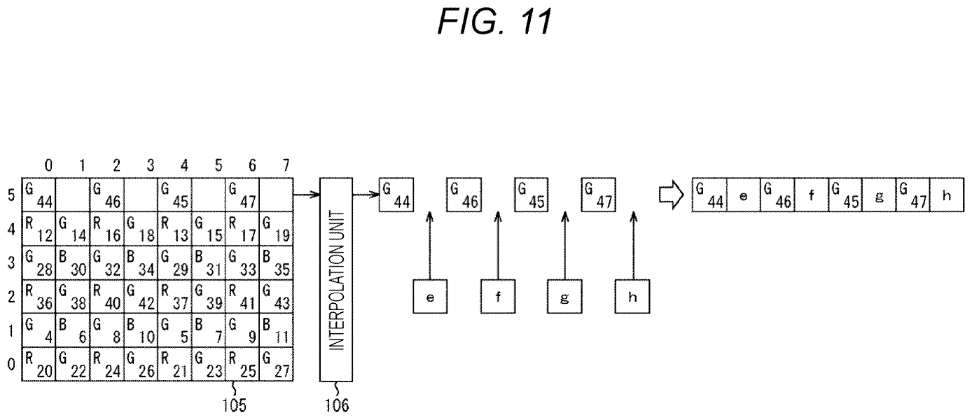

The pixel signals stored in the storage unit 105 are supplied to the interpolation unit 106. As in the row B described with reference to B of FIG. 10, the interpolation unit 106 executes processing of interpolating pixels on the row which has missing pixels because the row is the row in which the phase difference pixels P are arranged. This interpolation processing will be described with reference to FIG. 11.

The left diagram of FIG. 11 is the same as the right diagram of FIG. 8, and is a diagram illustrating a state in which the pixel signals are stored in the storage unit 105 in the same pixel array as the pixel array unit 11. When the pixel G44, the pixel G46, the pixel G45, and the pixel G47 arranged in the fifth row are read from the storage unit 105, a pixel e, a pixel f, a pixel g, and a pixel h are interpolated by the interpolation unit 106.

The pixel e is interpolated between the pixel G44 and the pixel G46, the pixel f is interpolated between the pixel G46 and the pixel G45, the pixel g is interpolated between the pixel G45 and the pixel G47, and the pixel h is added after the pixel G47. Since the pixels e to h are interpolated to the positions having the role of the blue pixel B, pixels having a value as the blue pixel B are generated and interpolated.

For example, the values of a plurality of pixels B located around the position where the pixel e is arranged can be read, an average value of the values can be calculated, and the interpolation can be performed by using the average value as the value of the pixel signal of the pixel e. The pixels f to h can also be generated as average values from other pixels. As the values of the pixels e and f, values other than the average value can be generated and used.

As described above, in the row having a small number of pixels, the pixels are interpolated and output with the same number of pixels as the other rows. The interpolation unit 106 does not perform any processing on a row (for example, a row corresponding to the row A) in which pixels do not need to be interpolated, and supplies the input pixels to the output control unit 107.

The pixels supplied to the output control unit 107 via the interpolation unit 106 are in a pixel array equivalent to the pixels read by raster scanning when the pixel array unit 11 has the Bayer array. Therefore, the post-stage processing unit 41 (FIG. 1) that processes the output from the output control unit 107 can be a processing unit that processes pixels read by raster scanning when the pixel array unit 11 has a Bayer array, and a processing unit (such as an LSI) in the related art can be used.

In the above-described embodiment, the case where the rearrangement in the vertical direction is performed after the rearrangement in the horizontal direction is performed has been described as an example, but the rearrangement in the horizontal direction may be performed after the rearrangement in the vertical direction is performed.

In the above-described embodiment, the case where the phase difference pixel is provided in the pixel array unit 11 has been described as an example, but the present technology can also be applied to a case where the phase difference pixel is not provided. In a case where the phase difference pixel is not provided in the pixel array unit 11, the processing regarding the phase difference pixel can be omitted in the description described above.

In the above-described embodiment, the case where the pixel array of the pixel array unit 11 is the Bayer array has been described as an example, but the present technology can also be applied to an array other than the Bayer array. For example, the present technology can also be applied to a case where a red pixel R, a green pixel G, a blue pixel B, and a white (transparent) pixel are arranged in the pixel array unit 11, a case where a pixel that receives infrared rays is arranged, and the like.

According to the present technology, even in a case where a method other than raster scanning is applied to the reading of the pixel signals from the pixel array unit 11, the post-stage processing unit 41 that processes the pixel signals from the pixel array unit 11 can perform processing in a similar manner to the case of reading by raster scanning. Therefore, an LSI that performs processing on the assumption that reading is performed by raster scanning from the pixel array unit 11 in a normal Bayer array in the related art can be used as the post-stage processing unit 41.

According to the present technology, a special reading format can be converted into a normal Bayer array format. By enabling the special reading format to be read at high speed, it is possible to support simultaneous exposure and simultaneous reading, that is, a so-called global shutter.

In a case of a circuit configuration for realizing simultaneous exposure of a global shutter, the reading format of the pixel signals from the pixel array unit 11 described above can be applied. As a circuit configuration thereof, as described above, the pixel array unit 11 can be divided into the plurality of blocks 12, and the same moving method (reading method) can be applied to all the blocks 12. By adopting such a common structure, downsizing of the device and reduction in power consumption can be realized.

### Regarding Recording Medium

The above-described series of processing can be performed by hardware or software. In a case where the series of processing is executed by software, a program constituting the software is installed in a computer. Here, examples of the computer include a computer incorporated in dedicated hardware, and for example, a general-purpose personal computer that can execute various functions by installing various programs.

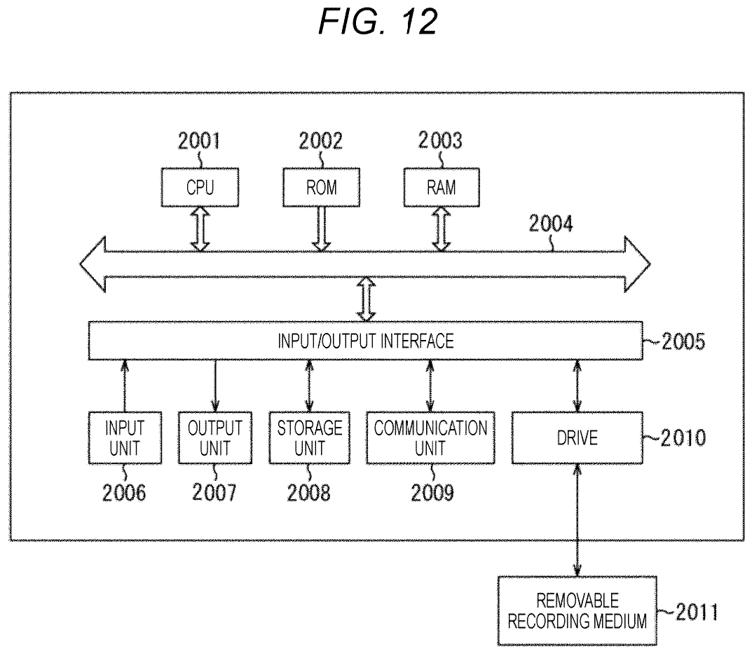

FIG. 12 is a block diagram illustrating a configuration example of hardware of a computer that executes the above-described series of processing by a program. In the computer, a central processing unit (CPU) 2001, a read only memory (ROM) 2002, and a random access memory (RAM) 2003 are connected to one another by a bus 2004. Moreover, an input/output interface 2005 is connected to the bus 2004. An input unit 2006, an output unit 2007, a storage unit 2008, a communication unit 2009, and a drive 2010 are connected to the input/output interface 2005.

The input unit 2006 includes a keyboard, a mouse, a microphone, and the like. The output unit 2007 includes a display, a speaker, and the like. The storage unit 2008 includes a hard disk, a nonvolatile memory, and the like. The communication unit 2009 includes a network interface and the like. The drive 2010 drives a removable medium 2011 such as a magnetic disk, an optical disk, a magneto-optical disk, or a semiconductor memory.

In the computer configured as described above, the CPU 2001 loads, for example, a program stored in the storage unit 2008 into the RAM 2003 via the input/output interface 2005 and the bus 2004, and executes the program, so that the above-described series of processing is performed.

The program executed by the computer (CPU 2001) can be provided by being recorded in the removable medium 2011 as a package medium or the like, for example. Furthermore, the program can be provided via a wired or wireless transmission medium such as a local area network, the Internet, or digital satellite broadcasting.

In the computer, the program can be installed in the storage unit 2008 via the input/output interface 2005 by mounting the removable medium 2011 on the drive 2010. Furthermore, the program can be received by the communication unit 2009 via a wired or wireless transmission medium and installed in the storage unit 2008. In addition, the program can be installed in advance into the ROM 2002 or the storage unit 2008.

Note that the program executed by the computer may be a program in which processing is performed in time series in the order described in the present specification or may be a program in which processing is performed in parallel or at necessary timing such as when a call is made.

In the present specification, the system represents the entire device including a plurality of devices.

Note that the effects described in the present description are merely examples and are not limited, and other effects may be provided.

Note that the embodiments of the present technology are not limited to the above-described embodiments, and various changes can be made without departing from the gist of the present technology.

Note that the present technology can also have the following configurations.

(1)

An imaging device including:
a pixel array unit in which pixels that generate charges according to an amount of light received and output signals according to the charges are arrayed in a matrix in a row direction and a column direction;
a reading unit that divides the pixel array unit into a plurality of blocks and reads a signal from the pixel at a same position in the block from each of the plurality of blocks; and
a rearrangement unit that performs rearrangement such that an array of the signals read by the reading unit is equivalent to an array of the pixels in the pixel array unit.

(2)

The imaging device according to (1),
in which the rearrangement unit includes:
a row direction rearrangement unit that rearranges the array of the pixels read from the reading unit such that the array in a row direction is equivalent to the array in the row direction of the pixels in the pixel array unit; and
a column direction rearrangement unit that rearranges the array of the pixels read from the reading unit such that the array in a column direction is equivalent to the array in the column direction of the pixels in the pixel array unit.

(3)

The imaging device according to (2),
in which the row direction rearrangement unit performs rearrangement such that the array of the pixels in the row direction is equivalent to the array in the row direction of the pixels in the pixel array unit when the signal is read from a first storage unit that stores the signal read from the pixel array unit.

(4)

The imaging device according to (2) or (3),
in which the column direction rearrangement unit performs rearrangement such that the array of the pixels in the column direction is equivalent to the array in the column direction of the pixels in the pixel array unit when the signal is read from a first storage unit that stores the signal read from the pixel array unit.

(5)

The imaging device according to any one of (2) to (4),
in which the row direction rearrangement unit performs rearrangement such that the array of the pixels in the row direction is equivalent to the array in the row direction of the pixels in the pixel array unit when the signal is read from a first storage unit that stores the signal read from the pixel array unit and is output to the column direction rearrangement unit.

(6)

The imaging device according to any one of (2) to (5),
in which the column direction rearrangement unit writes the signal output from the row direction rearrangement unit in a region of a second storage unit corresponding to a position of the pixel, of which the signal is read, in the pixel array unit.

(7)

The imaging device according to (6),
in which the column direction rearrangement unit performs compression processing when the column direction rearrangement unit writes the signal in the second storage unit.

(8)

The imaging device according to (7),
in which in a case where the compression processing is performed on a row having a smaller number of pixels than other rows, the pixels are interpolated and compressed in a same compression method as the other rows.

(9)

The imaging device according to any one of (1) to (8), further including:
an interpolation unit that, in a case where the signal output from the rearrangement unit is a signal from a row having a smaller number of pixels than other rows, performs interpolation by generating signals corresponding to missing pixels.

(10)

The imaging device according to (9),
in which an array of the pixels output from the interpolation unit is an array in a case where the signal is read by raster scanning from the pixel array unit.

(11)

An imaging method including:
by an imaging device including a pixel array unit in which pixels that generate charges according to an amount of light received and output signals according to the charges are arrayed in a matrix in a row direction and a column direction,
dividing the pixel array unit into a plurality of blocks and reading the signal from the pixel at a same position in the block from each of the plurality of blocks; and
performing rearrangement such that an array of the read signals is equivalent to an array of the pixels in the pixel array unit.

(12)

A program causing a computer that controls an imaging device including a pixel array unit in which pixels that generate charges according to an amount of light received and output signals according to the charges are arrayed in a matrix in a row direction and a column direction, to execute processing including steps of:
dividing the pixel array unit into a plurality of blocks and reading the signal from the pixel at a same position in the block from each of the plurality of blocks; and
performing rearrangement such that an array of the read signals is equivalent to an array of the pixels in the pixel array unit.

### REFERENCE SIGNS LIST

1 Imaging device
11 Pixel array unit
12 Block
21 Reading unit
31 Pre-stage processing unit
41 Post-stage processing unit
101 Input control unit
102 Storage unit
103 Horizontal rearrangement unit
104 Vertical rearrangement unit
105 Storage unit
106 Interpolation unit
107 Output control unit

1. An imaging device comprising:
a pixel array unit in which pixels that generate charges according to an amount of light received and output signals according to the charges are arrayed in a matrix in a row direction and a column direction;
a reading unit that divides the pixel array unit into a plurality of blocks and reads the signal from the pixel at a same position in the block from each of the plurality of blocks; and
a rearrangement unit that performs rearrangement such that an array of the signals read by the reading unit is equivalent to an array of the pixels in the pixel array unit.

2. The imaging device according to claim 1,
wherein the rearrangement unit includes:
a row direction rearrangement unit that rearranges the array of the pixels read from the reading unit such that the array in a row direction is equivalent to the array in the row direction of the pixels in the pixel array unit; and
a column direction rearrangement unit that rearranges the array of the pixels read from the reading unit such that the array in a column direction is equivalent to the array in the column direction of the pixels in the pixel array unit.

3. The imaging device according to claim 2,
wherein the row direction rearrangement unit performs rearrangement such that the array of the pixels in the row direction is equivalent to the array in the row direction of the pixels in the pixel array unit when the signal is read from a first storage unit that stores the signal read from the pixel array unit.

4. The imaging device according to claim 2,
wherein the column direction rearrangement unit performs rearrangement such that the array of the pixels in the column direction is equivalent to the array in the column direction of the pixels in the pixel array unit when the signal is read from a first storage unit that stores the signal read from the pixel array unit.

5. The imaging device according to claim 2,
wherein the row direction rearrangement unit performs rearrangement such that the array of the pixels in the row direction is equivalent to the array in the row direction of the pixels in the pixel array unit when the signal is read from a first storage unit that stores the signal read from the pixel array unit and is output to the column direction rearrangement unit.

6. The imaging device according to claim 2,
wherein the column direction rearrangement unit writes the signal output from the row direction rearrangement unit in a region of a second storage unit corresponding to a position of the pixel, of which the signal is read, in the pixel array unit.

7. The imaging device according to claim 6,
wherein the column direction rearrangement unit performs compression processing when the column direction rearrangement unit writes the signal in the second storage unit.

8. The imaging device according to claim 7,
wherein in a case where the compression processing is performed on a row having a smaller number of pixels than other rows, the pixels are interpolated and compressed in a same compression method as the other rows.

9. The imaging device according to claim 1, further comprising:
an interpolation unit that, in a case where the signal output from the rearrangement unit is a signal from a row having a smaller number of pixels than other rows, performs interpolation by generating signals corresponding to missing pixels.

10. The imaging device according to claim 9,
wherein an array of the pixels output from the interpolation unit is an array in a case where the signal is read by raster scanning from the pixel array unit.

11. An imaging method comprising:
by an imaging device including a pixel array unit in which pixels that generate charges according to an amount of light received and output signals according to the charges are arrayed in a matrix in a row direction and a column direction,
dividing the pixel array unit into a plurality of blocks and reading the signal from the pixel at a same position in the block from each of the plurality of blocks; and
performing rearrangement such that an array of the read signals is equivalent to an array of the pixels in the pixel array unit.

12. A program causing a computer that controls an imaging device including a pixel array unit in which pixels that generate charges according to an amount of light received and output signals according to the charges are arrayed in a matrix in a row direction and a column direction, to execute processing including steps of:
dividing the pixel array unit into a plurality of blocks and reading the signal from the pixel at a same position in the block from each of the plurality of blocks; and
performing rearrangement such that an array of the read signals is equivalent to an array of the pixels in the pixel array unit.
